(19) United States
(12) Patent Application Publication
(10) Pub. No.: US 2009/0151643 A1
(43) Pub. Date: Jun. 18, 2009

(54) Treat-Dispensing Tug Toy

(76) Inventor: Darryl Hodgins, Lucan (CA)

Correspondence Address: LITMAN LAW OFFICES, LTD., POST OFFICE BOX 15035, CRYSTAL CITY STATION, ARLINGTON, VA, 22215-0035, US

(21) Appl. No.: 12/314,685

(22) Filed: Dec. 15, 2008

Related U.S. Application Data
(60) Provisional application No. 61/006,032, filed on Dec. 14, 2007.

(51) Int. Cl. A01K 29/00; A01K 1/10

(52) U.S. Cl. 119/51.01; 119/707

(57) ABSTRACT

The treat-dispensing tug toy is a pet toy intended for the convenient dispensing of dog treats or similar chewable pet food during interactive play between a dog and its owner. The toy has a hollow, handle portion and a nose portion with a ring for attaching a rope or pull toy. The handle portion has an access hole with a removable cap and may be filled with dog treats. The handle portion ends in a sleeve with a plurality of holes spaced radially about its circumference. The nose portion slides over the sleeve. When a dog pulls on the rope or pull toy, the nose portion slides and uncovers the holes on the sleeve, thus dispensing the dog treats. The resistance of the treat dispensing tug toy may be adjusted to accommodate different sizes and breeds of dogs.

### CROSS-REFERENCE TO RELATED APPLICATION

This application claims the benefit of U.S. Provisional Patent Application Ser. No. 61/006,032, filed Dec. 14, 2007.

### BACKGROUND OF THE INVENTION

1. Field of the Invention

The present invention relates to pet toys, and more particularly to a treat-dispensing tug toy used for the entertainment and training of a dog.

2. Description of the Related Art

It is well known that interactive play between a pet and the pet's owner is extremely beneficial to both the pet and the owner. This type of interaction develops an emotional bond between the pet and the owner, and further provides exercise, training and sensory stimulation for the animal. Games and playtime activities involving pulling and tugging are a special favorite of dogs. Such games as “Tug of War” provide interaction between human and dog, and also provide mental stimulation, competition, and opportunities to be rewarded for desired behaviors for the dog.

Dogs, in particular, benefit from this type of interactive play. Tugging and pulling provides a health benefit for the dog by enabling the dog to exercise its jaws and teeth, and also is a fun activity for the dog and the owner. It would be desirable to provide a pet toy that provides for interaction between the pet and his owner and that dispenses a treat when the pet tugs the toy far enough in order to enhance the pet's enjoyment of the activity. Thus a treat dispensing tug toy for dogs solving the aforementioned problems is desired.

### SUMMARY OF THE INVENTION

The treat-dispensing tug toy is a pet toy intended for the convenient dispensing of dog treats or similar chewable pet food during interactive play between a dog and its owner. The toy has a hollow, handle portion and a nose portion with a ring for attaching a rope or pull toy. The handle portion has an access hole with a removable cap and may be filled with dog treats. The handle portion ends in a sleeve with a plurality of holes spaced radially about its circumference. The nose portion slides over the sleeve. When a dog pulls on the rope or pull toy, the nose portion slides and uncovers the holes on the sleeve, thus dispensing the dog treats. A bolt mounted inside the handle portion prevents the handle portion and the nose portion of the treat dispensing tug toy from being pulled completely apart, and a spring placed on the bolt pulls the two parts back together when the dog stops pulling on the rope or tug toy. The spring-bias can be increased or decreased by adjusting a thumb wheel on the handle portion to accommodate different sized dogs.

These and other features of the present invention will become readily apparent upon further review of the following specification and drawings.

### BRIEF DESCRIPTION OF THE DRAWINGS

FIG. 1 is a top view of a treat dispensing tug toy according to the present invention, shown in a closed position.

FIG. 2 is a top view of a treat dispensing tug toy according to the present invention, shown in an open position.

FIG. 3 is a side view of the treat dispensing tug toy according to the present invention.

FIG. 4 is a perspective view of a treat dispensing tug toy according to the present invention, with portions broken away and partially in section showing additional interior detail.

FIG. 5 is a bottom view of the treat dispensing tug toy according to the present invention, broken away and in partial section.

FIG. 6 is a bottom view of the treat dispensing tug toy according to the present invention, shown in a closed position.

Similar reference characters denote corresponding features consistently throughout the attached drawings.

### DETAILED DESCRIPTION OF THE PREFERRED EMBODIMENTS

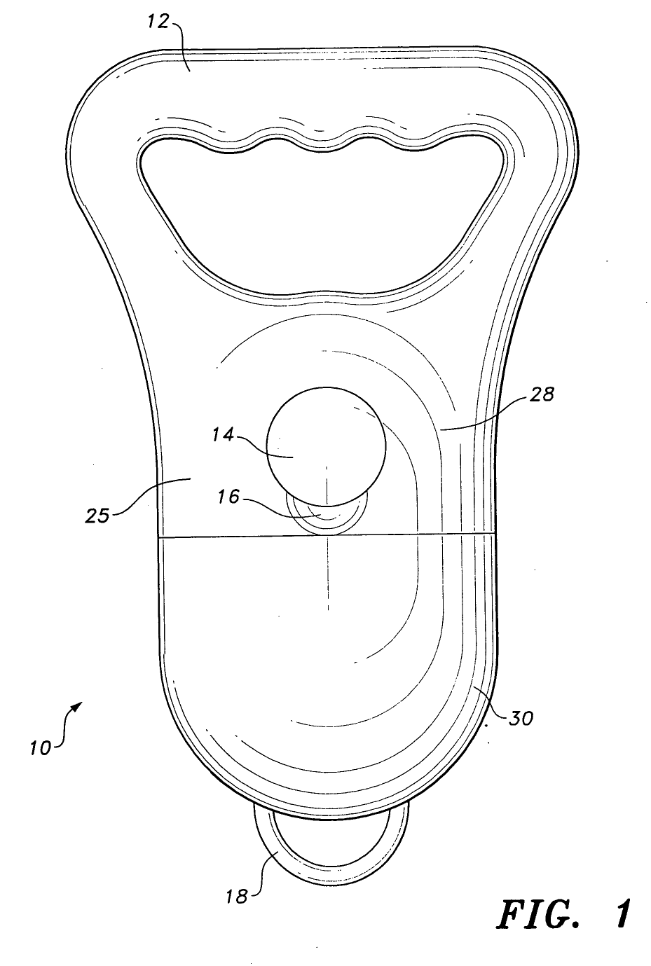

The present invention relates to a treat dispensing tug toy, hereinafter designated as 10, which is designed to dispense chewable pet treats during interactive play between a pet and an owner. As FIG. 1 illustrates, the treat dispensing tug toy has a housing having a handle portion 28 and a nose portion 30. The housing may be manufactured from plastic or a similar molded or extruded material. The handle portion 28 has a handgrip 12 shaped for comfortable gripping by a pet owner's hand. The handle portion 28 has a hollow, cylindrical shell 25 extending from the handgrip 12 that may be filled with individual chewable pet treats.

FIG. 1 shows an opening 16 defined in the handle 28 for access to the interior. Treats may be put into the treat dispensing tug toy through the opening 16. The opening 16 has a protective, removable cover 14. The cover 14 may be removed to load the toy with pet treats. When the protective removable cover 14 is in the closed position, the treats are prevented from falling out when the tug toy 10 is in use.

The nose portion 30 has a ring 18 attached at the end opposite the handgrip 12. A rope or a pet pull toy may be attached to the ring 18. Pulling by a pet on a rope or attached toy causes the handle portion 28 and the nose portion 30 to separate.

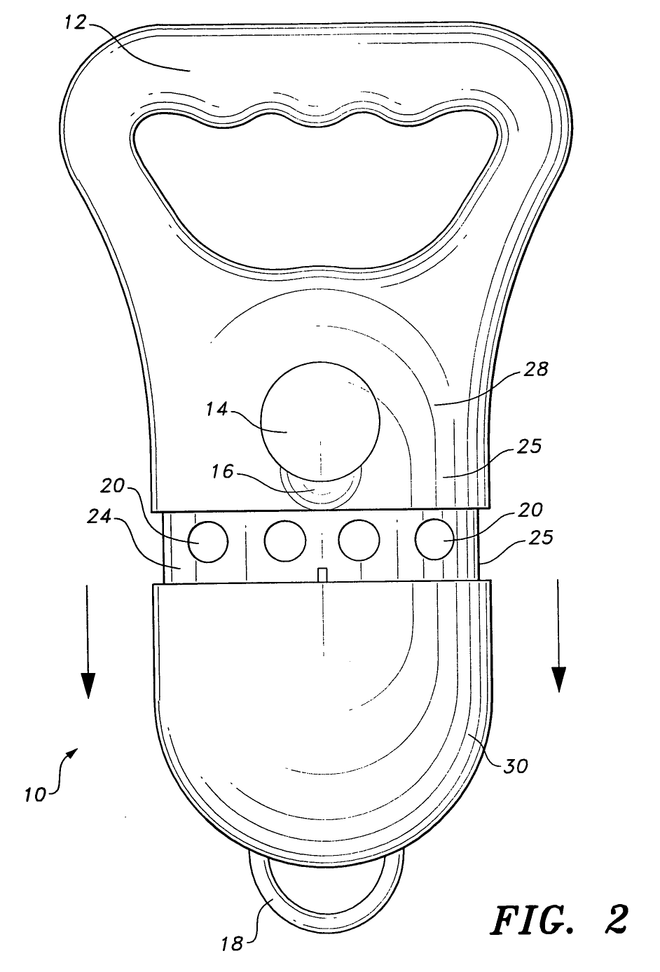

FIG. 2 shows the treat dispensing tug toy 10 in the open position. As indicated in FIG. 2, the handle portion 28 of the toy 10 has a sleeve 24 extending from the shell 25. The sleeve 24 has openings 20 radially spaced about the circumference of the sleeve 24. The sleeve 24 has a smaller diameter than the shell 25, defining a shoulder. The sleeve 24 fits into the nose portion 30 and slides freely inside the nose portion 30 as indicated by the directional arrows on FIG. 2, the nose portion abutting the shoulder between the sleeve 24 and shell 25 in the closed position. The sleeve 24 has a flexible cap across its end to retain the treats in the handle portion 12.

A pull by a pet on a rope or other pull toy attached to the ring 18 causes the handle portion 28 and nose portion 30 to slide apart, exposing the sleeve 24 and the openings 20 to dispense treats through the openings 20.

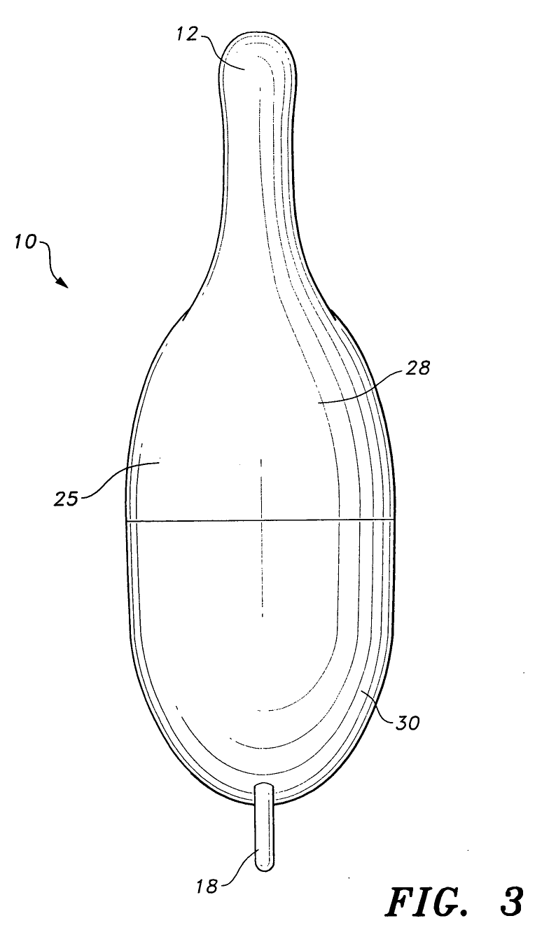

FIG. 3 is a side view of the treat dispensing tug toy 10 showing the relative positions of the handle 12, the ring 18, the handle portion 28, and nose portion 30 in the closed position.

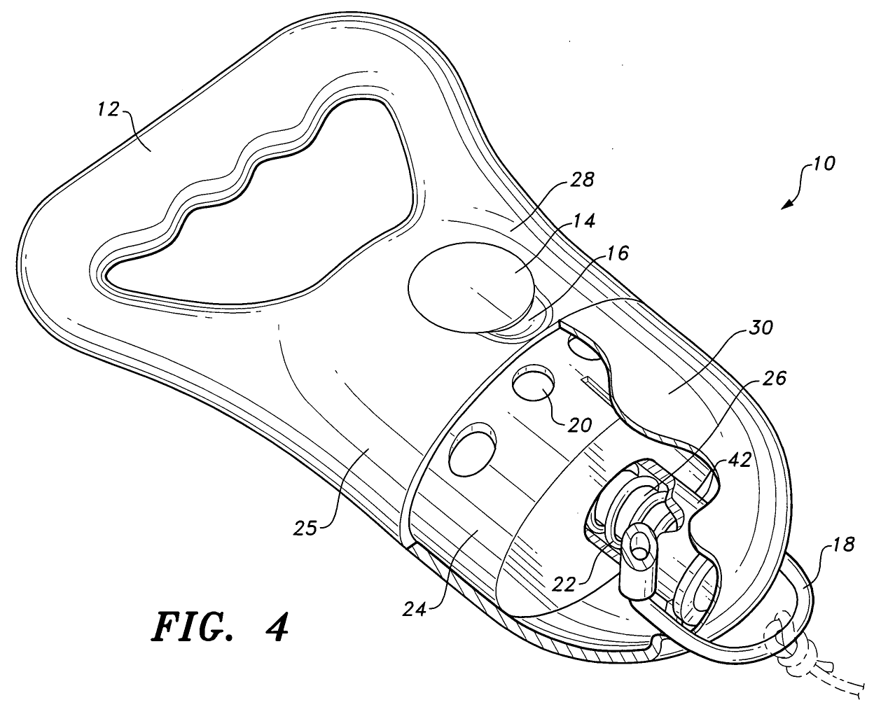

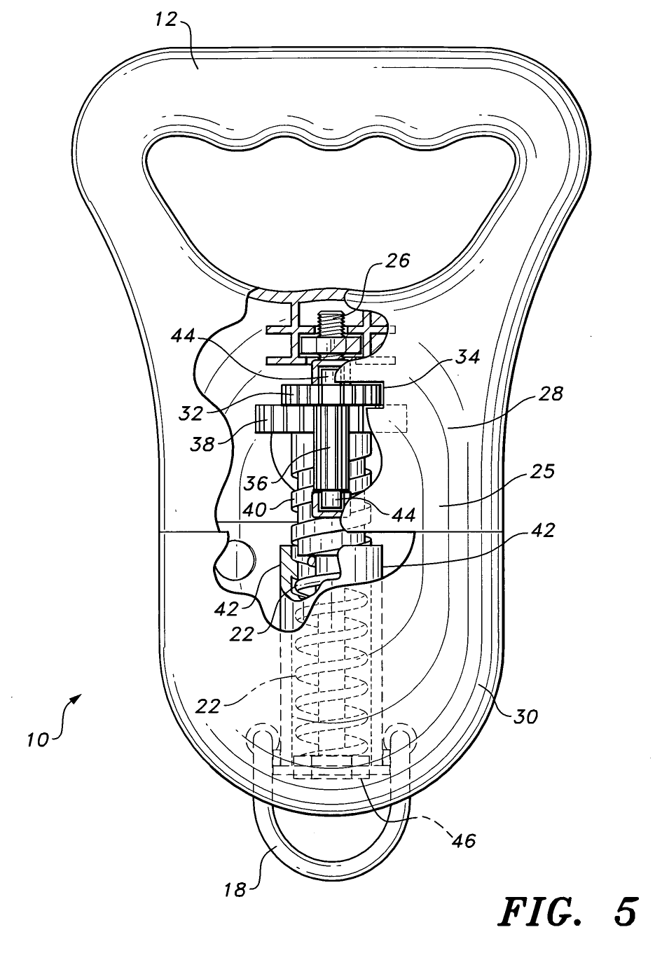

FIGS. 4 and 5 show the handle portion 28, the nose portion 30, and a longitudinal bolt 26, which is threaded into the interior of the handle portion 28. The head 46 of the bolt 26 extends into a cylinder 42 mounted in the interior of the nose portion 30. The cylinder 42 is threaded on its interior surface. The cylinder 42 has a diameter greater than the head 46 of the bolt 26 to allow the head 46 of the bolt 26 to freely travel through the cylinder 42. A spring 22 is disposed around the shaft of the bolt 26. The diameter of the spring 22 is smaller than the head 46 of the bolt 26. When the nose portion 30 is pulled by a rope or tug toy attached to the ring 18, the movement of the bolt 26 through the cylinder 42 causes compression of the spring 22. When the pull on the rope or other pull toy attached at the ring 18 ceases, extension of the spring 22 pushes the bolt 26 back into the cylinder 42 and causes the handle portion 28 and nose portion 30 to slide back into the closed position illustrated in FIG. 1 and FIG. 3.

FIG. 5 illustrates the mechanism for adjusting the tension of the spring 22 and resulting spring-bias for adjusting the treat dispensing tug toy 10 for use by different sizes or breeds of animals. The user turns a thumbwheel 32 projecting though a port 34 in the handle portion 12. The thumbwheel 32 is mounted on a splined shaft 36. The splined shaft 36 rotates in bearings 44 on each end of the splined shaft 36, which are mounted on the handle portion of the housing 28. Rotation of the thumbwheel 32 causes the splines on shaft 36 to engage a spur gear 38. The spur gear 38 is attached to a hollow threaded shaft 40 longitudinally disposed on the bolt 26 and extending down the bolt 26 to bear against the spring 22.

The threaded shaft 40 has a larger diameter than the bolt 26 to allow the bolt 26 to freely travel through the shaft 40, but does not permit the spring 22 to pass through the threaded shaft 40. The threads on the threaded shaft 40 engage the interior threads of the cylinder 42 mounted in the nose portion 30 of the housing. As the threaded shaft 40 turns and is engaged by the cylinder 42, shaft 40 causes compression of the spring 22. The large threads on the threaded shaft 40 provide for a 360° rotation of the threaded shaft 40 and complete compression of the spring 22 with only two or three turns of the thumbwheel 32. When the spring 22 is fully compressed, more force is required to separate the handle portion 28 of the housing from the nose portion 30. This setting may be appropriate for a larger or more aggressive dog.

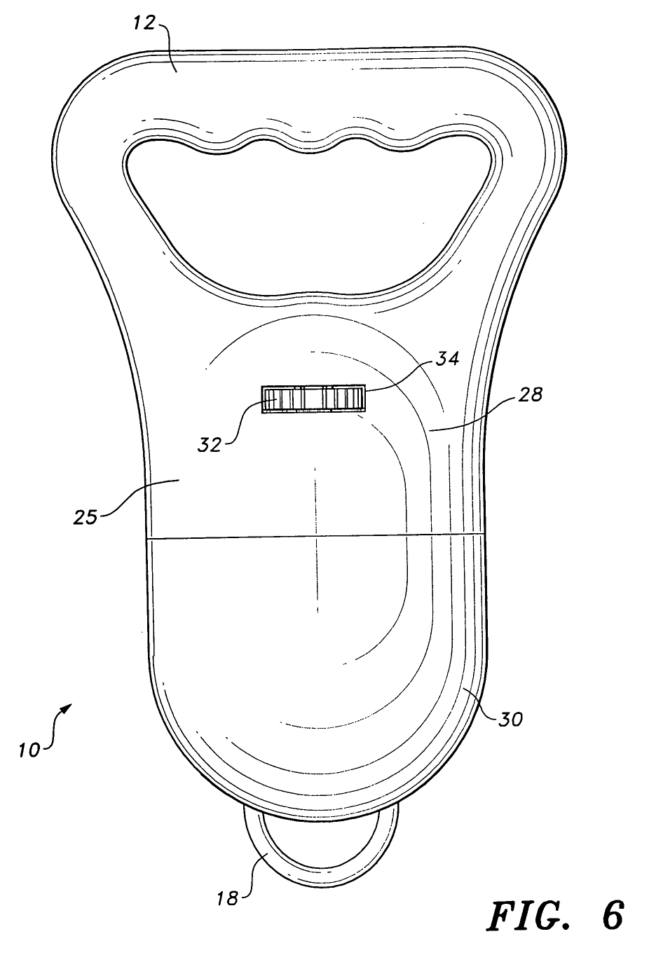

FIG. 6 is a bottom view that illustrates the position of the port 34 and the thumbwheel 32 in the handle portion 28 of the housing.

It is to be understood that the present invention is not limited to the embodiments described above, but encompasses any and all embodiments within the scope of the following claims.

I claim:

1. A treat dispensing tug toy comprising:
a housing having:
a handle portion having a handgrip, a hollow cylindrical shell extending from the handgrip defining a treat storage chamber, and a dispensing sleeve extending from the shell, the dispensing sleeve having a plurality of radially spaced treat-dispensing openings defined therein for dispensing treats, the cylindrical shell having a refill opening defined therethrough for filling the treat storage chamber with treats and a removable cover disposed over the refill opening; and
a nose portion slidably mounted over the dispensing sleeve, the nose portion selectively covering the plurality of treat-dispensing openings; and
means for resiliently biasing the nose portion to a closed position completely covering the sleeve and abutting the cylindrical shell, the nose portion being slidable to an open position uncovering the treat-dispensing openings when a pet tugs the nose portion away from the handle portion.

2. The treat dispensing tug toy as recited in claim 1, wherein said means for resiliently biasing the nose portion comprise:
a bolt having opposed first and second ends, the first end being threaded into the handle portion of said housing, the second end having a head extending into the nose portion of said housing; and
a helical spring mounted within the nose portion about the bolt, the helical spring bearing against the head of the bolt.

3. The treat dispensing tug toy as recited in claim 2, wherein the bolt is threaded.

4. The treat dispensing tug toy as recited in claim 3, further comprising a hollow cylinder having a threaded interior surface, the hollow cylinder being mounted within the nose portion of said housing, the threaded interior surface of the hollow cylinder having a diameter greater than the bolt, allowing the bolt to freely pass through an interior of the hollow cylinder, the helical spring being disposed within the interior of the hollow cylinder.

5. The treat dispensing tug toy as recited in claim 4, further comprising means for selectively adjusting bias applied by the helical spring.

6. The treat dispensing tug toy as recited in claim 5, wherein said means for selectively adjusting bias comprise:
a hollow threaded shaft disposed about at least a portion of the bolt, the hollow threaded shaft having opposed first and second ends, the second end bearing against the helical spring;
a spur gear mounted on the hollow threaded shaft; and
a splined shaft rotatably mounted within the handle portion of said housing, the splined shaft engaging the spur gear so that selective rotation of the splined shaft drives rotation of the spur gear and the hollow threaded shaft.

7. The treat dispensing tug toy as recited in claim 6, further comprising a thumbwheel mounted on the splined shaft, the thumbwheel partially projecting through a port formed through the handle portion of said housing, whereby selective rotation of the thumbwheel by a user drives rotation of the splined shaft.

8. The treat dispensing tug toy as recited in claim 7, wherein the hollow threaded shaft has a diameter greater than the bolt, allowing the bolt to freely travel therethrough, the hollow threaded shaft threadedly engaging the threaded interior surface of the hollow cylinder.

9. The treat dispensing tug toy as recited in claim 1, wherein the handle portion has an opening formed therethrough, the opening defining the handgrip.

10. The treat dispensing tug toy as recited in claim 1, further comprising a ring attached to the nose portion.

11. A treat dispensing tug toy comprising:
a housing having:
a handle portion having a handgrip, a hollow cylindrical shell extending from the handgrip defining a treat storage chamber, and a dispensing sleeve extending from the shell, the dispensing sleeve having a plurality of radially spaced treat-dispensing openings define therein for dispensing treats, the cylindrical shell having a refill opening defined therethrough for filling the treat storage chamber with treats and a removable cover disposed over the refill opening; and
a nose portion slidably mounted over the dispensing sleeve, the nose portion selectively covering the plurality of treat-dispensing openings;
means for resiliently biasing the nose portion to a closed position completely covering the sleeve and abutting the cylindrical shell, the means including a resilient element disposed within the nose portion, the nose portion being slidable to an open position uncovering the treat-dispensing openings when a pet tugs the nose portion away from the handle portion; and
means for selectively adjusting bias applied by the resilient element.

12. The treat dispensing tug toy as recited in claim 11, wherein the resilient element comprises a helical spring, the tug toy further comprising a bolt having opposed first and second ends, the first end being threaded into the handle portion of said housing, the second end defining a head of the bolt extending into the nose portion of said housing, the helical spring being disposed within the nose portion about the bolt, the helical spring bearing against the head of the bolt.

13. The treat dispensing tug toy as recited in claim 12, wherein the bolt is threaded.

14. The treat dispensing tug toy as recited in claim 13, further comprising a hollow cylinder having a threaded interior surface, the hollow cylinder being mounted within the nose portion of said housing, the threaded interior surface of the hollow cylinder having a diameter greater than the bolt, allowing the bolt to freely pass through an interior of the hollow cylinder, the helical spring being disposed within the interior of the hollow cylinder.

15. The treat dispensing tug toy as recited in claim 14, wherein said means for selectively adjusting bias applied by the resilient element comprises:
a hollow threaded shaft disposed about at least a portion of the bolt, the hollow threaded shaft having opposed first and second ends, the second end bearing against the helical spring;
a spur gear mounted on the hollow threaded shaft; and
a splined shaft rotatably mounted within the handle portion of said housing, the splined shaft engaging the spur gear so that selective rotation of the splined shaft drives rotation of the spur gear and the hollow threaded shaft.

16. The treat dispensing tug toy as recited in claim 15, further comprising a thumbwheel mounted on the splined shaft, the thumbwheel partially projecting through a port formed through the handle portion of said housing, whereby selective rotation of the thumbwheel by a user drives rotation of the splined shaft.

17. The treat dispensing tug toy as recited in claim 16, wherein the hollow threaded shaft has a diameter greater than the bolt, allowing the bolt to freely travel therethrough, the hollow threaded shaft threadedly engaging the threaded interior surface of the hollow cylinder.

18. The treat dispensing tug toy as recited in claim 11, wherein the handle portion has an opening formed therethrough, the opening defining the handgrip.

19. The treat dispensing tug toy as recited in claim 11, further comprising a ring attached to the nose portion.
